(19) United States
(12) Patent Application Publication
(10) Pub. No.: US 2007/0259311 A1
(43) Pub. Date: Nov. 8, 2007

(54) Tooth prosthesis carrier implant

(76) Inventor: Thomas Laux, Steppach/Neusass (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/711,186

(22) Filed: Feb. 26, 2007

(30) Foreign Application Priority Data
May 6, 2006 (DE) 10 2006 021 181.2

(51) Int. Cl. A61C 19/00; A61C 1/14

(52) U.S. Cl. 433/53; 433/49

(57) ABSTRACT

In a tooth prosthesis carrier implant including a carrier post, a carrier element supported on the carrier post for supporting a tooth crown or a tooth prosthesis, and a spring element disposed between the carrier post and the carrier element for biasing the carrier element away from the carrier post, an elastomer material is introduced as a liquid into the space between the carrier post and the carrier element so that, after curing, the elastomer material firmly interconnects the carrier element and the carrier post.

### BACKGROUND OF THE INVENTION

The invention relates to a tooth prosthesis carrier implant, that is, a carrier for implantation into the jaw of a patient for supporting a tooth prosthesis in the form of a single tooth crown or a multi-tooth prosthesis wherein an axially effective compression spring is disposed between a carrier post and a carrier element.

Tooth prosthesis carrier implants of the above type are known for example from DE 101 49 166 C1 and DE 103 36 537 B3. In the arrangement according to DE 101 49 166 C1, the carrier implant consists of a carrier post comprising a root section for implantation into the jaw and a post section screwed onto the root post. On the carrier post, a two-part carrier cover is disposed which comprises a sleeve-like bottom part and a cap-like top part. The sleeve-like bottom part of the carrier cover is firmly connected to the post section of the carrier post and the cap-like top part of the carrier cover is mounted onto the bottom part in a form-locking manner, but with a certain play. Between the bottom part and the top part of the two-part carrier cover a spiral compression spring is arranged between two axially opposite shoulders of the two parts together with a seal ring in the form of a rubber ring which also forms a spring element. The spiral compression spring forces the top and bottom parts apart while the seal ring serves as a shock absorber. In addition, the bottom part and the top part of the carrier cover axially overlap over a certain distance along cooperating cylinder surfaces. In the arrangement according to DE 103 36 537, the carrier cover is a one-piece structure and connected to the carrier post in a form-locking manner. The arrangement also includes a spiral spring resiliently biasing the carrier cover apart from the carrier post. Also in this arrangement, the carrier cover and the carrier post overlap over a certain distance via cooperating cylinder surfaces.

It is the object of the present invention to provide an improved tooth prosthesis carrier implant of the type as disclosed above.

### SUMMARY OF THE INVENTION

In a tooth prosthesis carrier implant including a carrier post, a carrier element supported on the carrier post for supporting a tooth crown or a tooth prosthesis, and a spring element disposed between the carrier post and the carrier element for biasing the carrier element away from the carrier post, an elastomer material is introduced as a liquid into the space between the carrier post and the carrier element so that, after curing, the elastomer material firmly interconnects the carrier element and the carrier post.

In the tooth prosthesis carrier implant according to the invention, the carrier cover, which accommodates the tooth crown or tooth prosthesis, cannot only be made as a single piece and therefore be relatively simple but it has, in comparison with the conventional carrier implants, substantial advantages in that the carrier cover and the carrier post are, as a result of the connection via the elastic material inserted between these parts and contained therebetween, not only elastically resiliently movable to a certain degree relative to each other but also sidewardly or, respectively, angularly. A form-locking connection with the carrier post can be established but is not necessary. Between the carrier post and the carrier cover, a spring element may again be provided for example in the form of a spiral compression spring which biases the carrier cover axially away from the carrier post. The whole gap area between the carrier post and the carrier cover is filled with an elastic material which is introduced in liquid form and cured in place and which interconnects the carrier post and the carrier cover in a resilient and sealing manner while permitting a certain amount of relative movements. As mentioned the motion capability is not only provided in axial direction providing a shock absorber function but also provides for sideward or angular resiliency so that, upon mounting of a crown or prosthesis, an alignment or position adaptation is facilitated. The elastic shock absorber effect of the elastic material between the carrier cover and the carrier post adds to the spring force. Herein, the spring and the elastic material do not only support each other in the shock absorbing effect, but the spring is also much less stressed then in the carrier implants referred to in the introduction so that failure of the spring is not to be expected.

Instead of a carrier cover an other carrier part for example in the form of a carrier head of any shape may be provided which is connected to the carrier post-like the carrier cover described.

With respect to the known carrier implant, the arrangement according to the invention does not only have the advantage of a more universal movement play between the carrier post and the carrier cover, but it also simplifies the preparation of the components and also the installation and it provides for optimal sealing between the carrier post and the carrier cover or, respectively, carrier head. In contrast to the conditions present in conventional carrier implants where leakages may occur between the relatively movable parts of the carrier cover, particularly in the axial overlap area between the bottom part and the carrier cover, in the arrangement according to the invention a complete seal is established between the carrier post and the carrier cover or carrier head, so that saliva or other materials or germs cannot enter.

In the carrier implant according to the invention, the spring element between the carrier post and the carrier cover or, respectively, carrier head has the main function of holding the carrier part and the carrier cover or -head apart as long as the elastic material is still liquid that is until it is cured so that the elastic material can subsequently fulfill its shock absorbing and accommodation functions while the spring element then has a support function as mentioned already earlier.

Below two embodiments of the invention will be described in greater detail on the basis of the accompanying drawings.

### BRIEF DESCRIPTION OF THE DRAWINGS

FIG. 1 is a cross-sectional view of an embodiment with a carrier cover,

FIG. 2 is a cross-sectional view of the embodiment of FIG. 1 showing the cover slightly tilted, and

FIG. 3 is a cross-sectional view of an embodiment with a carrier head for accommodating a prosthesis.

### DESCRIPTION OF THE TOOTH IMPLANT EMBODIMENTS

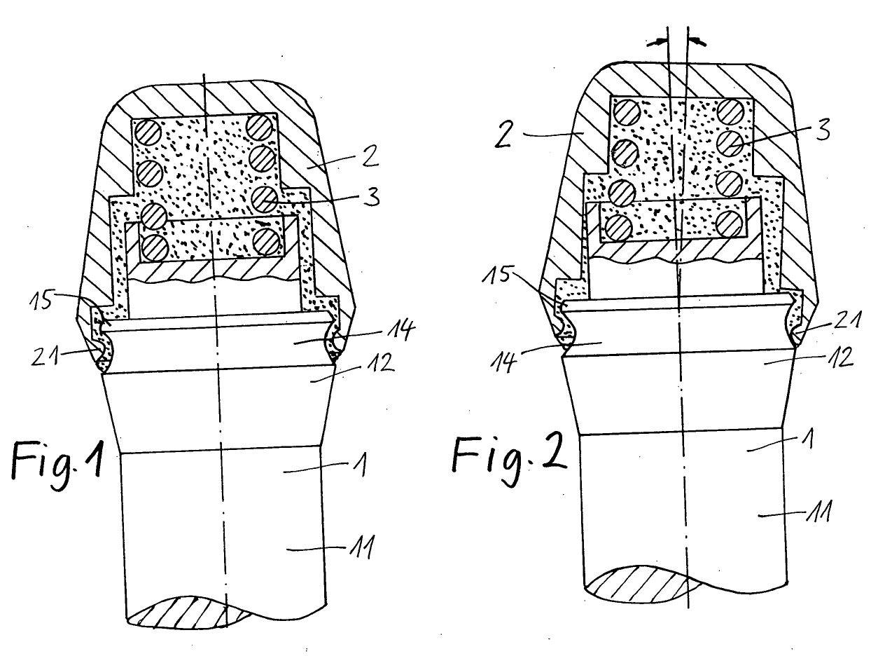

The arrangement as shown in FIGS. 1 and 2 comprises a carrier post 1 with a lower root part 11 for implantation into the jaw of a patient and an upper post part 12. The root part 11 and the post part 12 may consist of a single piece. The embodiments are of course shown only schematically and in particular the representation of the root part is only indicative of its presence but not of its actual shape which corresponds to that of conventional tooth implants.

On top of the post part 12 of the carrier post 1, a carrier cover 2 is arranged which serves as carrier element for a tooth crown or a tooth prosthesis.

A spiral compression spring 3 is arranged between the carrier cover 2 and the upper end of the carrier post 1 which forms a spring plate 13 on which the spring is seated and biases the carrier cover 2 axially away from the carrier post 1.

As apparent from the figures, the post part 12 of the carrier post 1 has, in the area of the carrier cover edge, an annular groove 14 of for example partial circular cross-section into which an annular bead 21 formed at the radially inner side of the carrier cover lower edge projects. The arrangement is such that, upon installation on the carrier post part 12, the carrier cover is moved with its annular bead 21 over an inclined surface area 15 above the annular groove 14 so that it engages in the annular groove 14 in a form-locking relation therewith for firm connection between the carrier cover 2 and the carrier post 1.

Before the carrier cover 2 is placed onto the carrier post 1, the inner surfaces of the carrier cover 2 and the surfaces of the carrier post part 12 to be covered by the carrier cover 2 are treated with a suitable primer forming a tie layer. Then the spiral compression spring 3 is inserted into the carrier cover 2 and an amount of liquid silicon or another suitable elastomer material is filled into the carrier cover. Then the carrier cover 2 is placed onto the carrier post 1 and pressed onto the carrier post 1 so that the bead 21 at the lower carrier cover edge engages into the annular groove 14 of the post part 12 whereby the post 1 and the carrier cover 2 are joined. In this process, the compression spring 3 is somewhat compressed and excess silicon or elastomer material is squeezed out. The form-locking connection between the bead 21 and the annular groove 14 prevents a separation of the carrier cover 2 and the carrier post 1 has a result of the pressure generated by the compression spring 3 which biases the carrier cover 2 away from the carrier post 1.

After curing of the silicon or, respectively, the elastomer material, the carrier post 1 and the carrier cover 2 are securely joined with the elastomer material disposed therebetween serving as a buffer and spring element forming, at the same time, a seal structure, which permits a certain axial and tilt movement between the carrier post and the carrier cover. The possible angular displacement is shown in FIG. 2.

The carrier post 1 and the carrier cover 2 may be made from titanium or zirconium oxide.

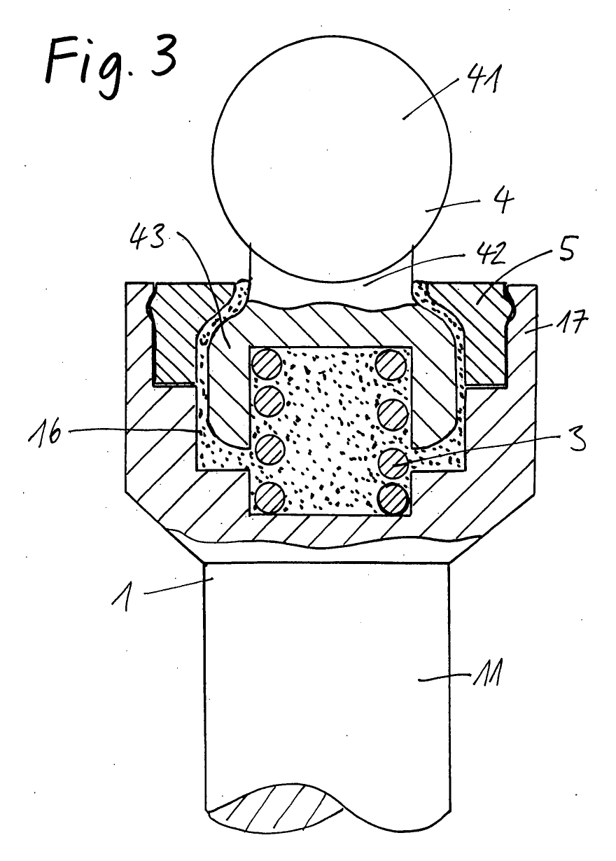

In the embodiment as shown in FIG. 3, instead of a carrier cover, a carrier part 4 is provided which includes a bone head like shape with a ball structure 41 for supporting a prosthesis. The ball structure 41 is connected by means of a neck part 42 with a lower knob-like part 43, which is received in a recess 16 which is formed in the upper end of the carrier post 1 and which is closed at the top by an annular collar 5 engaged in a circumferential edge portion 17 of the carrier post 1. Between the carrier post and the knob-like part 43 of the carrier part 4, there is again a spiral compression spring 3 disposed in the chamber 16 which is also filled with a suitable elastomer material.

In both embodiments of course, the spring element 3 does not need to be a spiral compression spring but another suitable spring element may be provided instead.

What is claimed is:

1. A tooth prosthesis carrier implant comprising a carrier post (1), a carrier element (2, 4) supported on the carrier post (1) for supporting a tooth crown or a tooth prosthesis, a spring element (3) disposed between the carrier post (1) and the carrier element (2, 4) so as to bias the carrier element (2, 4) axially away from the carrier post (1) and an elastomer material which is introduced into a space formed between the carrier post (1) and the carrier element (2, 4) in liquid form so as to completely fill the space whereby, after in situ curing of the elastomer material, the carrier element (2, 4) is firmly attached to the carrier post (1) by way of the elastomer material.

2. The tooth prosthesis carrier implant according to claim 1, wherein the carrier element (2, 4) is in the form of a carrier cover (2) extending over the upper part (12) of the carrier post (1).

3. The tooth prosthesis carrier implant according to claim 2, wherein between the upper part (12) of the carrier post (1) and a circumferential edge area of the carrier cover (2) an axially effective form-locking connection (14, 21) is provided which limits the relative movement distance of the carrier cover (2) away from the carrier post (1) under the force of the spring element (3).

4. The tooth prosthesis carrier implant according to claim 3, wherein the form-locking connection comprises an engagement structure between at least a radially inwardly projecting edge area (21) of the carrier cover (2) and a counter engagement structure (14, 15) formed on the carrier post (1) and receiving the edge area (21).

5. The tooth prosthesis carrier implant according to claim 1, wherein the carrier element (4) includes a carrier head (41) connected to a knob-like part (43) via a neck (42) and the carrier post (1) includes an upper chamber (16) in which the knob-like part (43) of the carrier element (4) is accommodated.

6. The tooth prosthesis carrier implant according to claim 5, wherein the lower knob-like part (43) of the carrier element (4) is secured in the chamber (16) by an annular collar (5).

7. The tooth prosthesis carrier implant according to claim 1, wherein the spring element (3) is a spiral compression spring.

8. The tooth prosthesis carrier implant according to claim 1, wherein the elastomer material is joined to the surfaces of the carrier post (1) and the carrier element (2, 4) by means of a tie layer applied to the surfaces of the carrier post (1) and the carrier element (2, 4).
